(19) United States
(12) Patent Application Publication
(10) Pub. No.: US 2011/0253421 A1
(43) Pub. Date: Oct. 20, 2011

(54) YOKE AND INSULATING ASSEMBLY

(75) Inventors: Wei-Chung Lin, Birmingham, AL (US); Edward J. Niedospial, West Chicago, IL (US)

(73) Assignee: MACLEAN POWER, LLC, York, SC (US)

(21) Appl. No.: 13/045,487

(22) Filed: Mar. 10, 2011

Related U.S. Application Data
(60) Provisional application No. 61/312,662, filed on Mar. 10, 2010.

(51) Int. Cl. H01B 17/16

(52) U.S. Cl. 174/163 R

(57) ABSTRACT

Disclosed herein are embodiments of a yoke for holding electric power lines, comprising a plate that is configured to be attached to a utility structure, an arm provided with a spacer, an extension, and a securing structure wherein the arm is shaped to retain a plurality of clamps, including a first clamp and a second clamp; each of the clamps is configured to retain an electric line; the spacer is provided with a curved section that forms a recess that is shaped to cooperate with at least one of the clamps, and the extension is dimensioned to separate the second clamp from the first clamp.

### RELATED APPLICATIONS

This application claims benefit of U.S. Provisional Patent Application Ser. No. 61/312,662, filed Mar. 10, 2010, the disclosure of which is incorporated herein by reference.

### FIELD

Embodiments disclosed herein relate to pole line hardware for electric power lines and insulators associated therewith.

### STATUS

This application claims priority to Yoke and Insulating Assembly, Provisional Application No. 61/312,662, the disclosure of which is incorporated herein by reference.

### BACKGROUND

It is known to use the dielectric properties of air to insulate electric power lines and prevent dangerous and destructive arcing between lines and conductive surfaces. Accordingly, lines have historically been installed on structures that enabled electric power to be transmitted safely overhead.

However, with overhead installation, lines are exposed to the elements, such as cold, heat, and high winds. To allow lines to expand and contract and to avoid stress failures from high tension, lines are installed with some slack. In high winds, the slack causes the lines to move to and fro. As a result, lines must be movably secured to those structures carrying lines overhead and the structure itself must be sufficiently stable in order to tolerate the never-ending back-and-forth motion of the lines.

To accomplish this objective, utilities have used steel towers with a wide foot print and a lattice structure for strength, along with suspension clamps to hold lines securely, but movably, as electric power is transmitted and distributed. These steel lattice structures have been provided with outwardly extending arms that separate lines and electrically conducting surfaces and contact points. Thus, the outwardly extending arms utilize the dielectric properties of air to insulate lines and prevent dangerous and destructive arcing from taking place while the suspension clamps enable the lines to move with high winds rather than snap from the stresses of being placed in high tension.

The wide footprint of the lattice structure have proven durable, however, there are drawbacks. The wide foot print required the purchase of more real estate and easement rights, an expensive proposition. Furthermore, the lattice structure required considerable material and labor to assemble, adding still more cost and expense. Faced with these considerable costs, electric utilities looked to use existing utility poles to expand the electric service and carry additional lines.

Unfortunately, however, adding lines to existing poles is problematic. Utility poles offer only a limited span and hence a limited amount of separation between lines; a necessary consequence of this limited physical separation between lines is that utility poles represent a challenge when engineers attempt to provide sufficient electric insulation between lines. Compounding the challenge, the necessary use of movable suspension clamps creates swing angles so that in a high winds, the lines can move to a fro. These swing angles must be factored in when determining an appropriate separation distance between lines and conducting surfaces. As a result, swing angles limit the amount of separation and hence electric insulation, a utility pole can provide. Consequently, these swing angles and the limited span offered on utility poles has prevented utilities from adding additional lines to existing infrastructure.

The present invention is directed to overcoming these and other disadvantages that will be apparent to one of ordinary skill in the art after reading the following written description of the presently preferred embodiment. The present invention is directed to overcoming these and other disadvantages inherent in prior art systems. Other advantages will be revealed in the following specification.

### SUMMARY

The scope of the present invention is defined solely by the appended claims, and is not affected to any degree by the statements within this summary. Disclosed herein are embodiments of a yoke for holding electric power lines, comprising a plate that is configured to be attached to a utility structure, an arm provided with a spacer, an extension, and a securing structure wherein the arm is shaped to retain a plurality of clamps, including a first clamp and a second clamp; each of the clamps is configured to retain an electric line; the spacer is provided with a curved section that forms a recess that is shaped to cooperate with at least one of the clamps, and the extension is dimensioned to separate the second clamp from the first clamp.

### BRIEF DESCRIPTION OF THE DRAWINGS

FIG. 1 is a side view of an insulating assembly with suspension clamps with electric lines shown within the suspension clamps cross-sectionally.

FIG. 2 is a side view of an insulating assembly.

FIG. 3 is a yoke with holes and the outline of a flange shown in dashed lines.

FIG. 4 is a side view of a yoke with suspension clamps holding electric power lines (which are shown in cross-section).

FIG. 5 is a side view of a yoke.

FIG. 6 is side view of a suspension clamp.

FIG. 7 is a view of a suspension clamp with an electric line shown therein cross-sectionally.

FIG. 8 is side view of a shackle.

FIG. 9 is a cross-sectional view of an end of a shackle.

### DETAILED DESCRIPTION

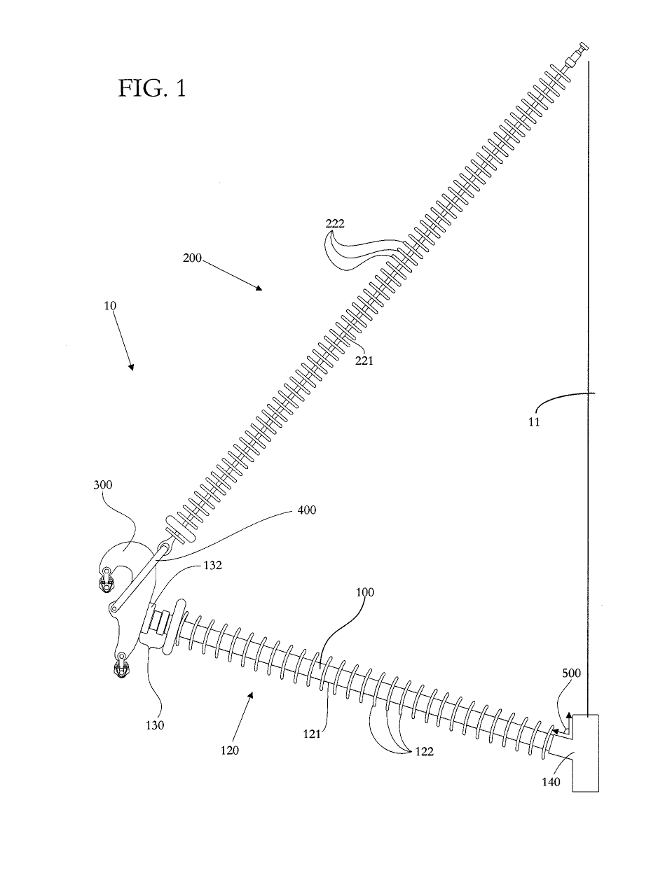

FIG. 1 depicts a presently preferred embodiment of an insulating assembly (which has been designated generally “10”). As shown therein, the insulating assembly 10 is provided with a first insulator 100, a second insulator 200, a yoke 300, and a connecting element 400 (which in the case of the preferred embodiment is a “shackle”).

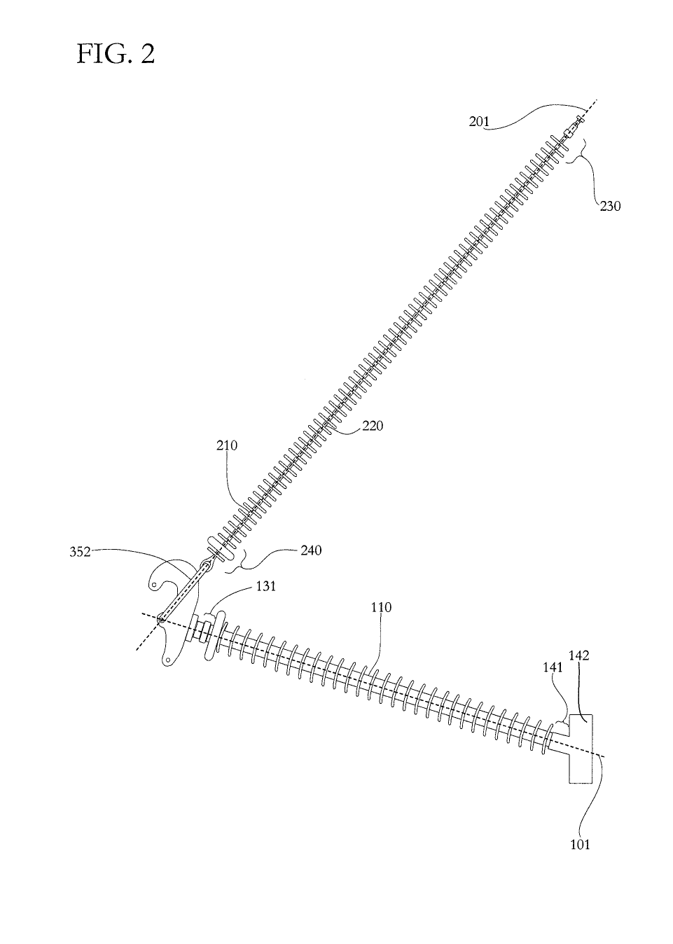

Referring now to FIG. 2, the first insulator 100 is a brace-post insulator (or “bracing insulator”) provided with a body 110 composed of a composite material; preferably, the composite material is a fiberglass extruded as a cylinder and provided with an axis 101, a housing 120 of silicone rubber is molded over the body 100. As FIG. 1 illustrates, the housing 120 is provided with a sheath 121, a plurality of sheds 122, and a housing axis 123. While the preferred embodiment is provided with a body 110 of extruded fiberglass and a housing 120 of silicone rubber molded thereon, in an alternative embodiment, the fiber of the body 110 is a polyester or an aramid, and the housing 120 is rubber that has been extruded onto the body 110. In yet another alternative embodiment, the housing 120 is composed of an RTV rubber or an EPDM.

The first insulator 100 is provided with a plurality of fittings that have been crimped onto each end 130, 140 of the body 110. As used herein, the term “end” refers to the extreme end as well as portions extending therefrom. As FIG. 1 illustrates, the first insulator 100 is provided with a mounting fitting 140, which is configured to be mounted onto a utility structure, preferably a utility pole 11, as is shown in FIG. 1. The mounting fitting 140 is provided with a mounting plate 142 and a body-accepting portion 141 that are integrally cast in a sand mold (and shown in FIG. 2). The body-accepting portion 141 is shaped according to the body 110, and hence is provided with a cylindrical opening and an inner surface that is cylindrical about an axis. The body-accepting portion 141 and its axis are oriented to extend from the plate at an angle 600 that measures between 10° and 15° (ideally)12°.

As FIG. 1 also shows, the first insulator 100 is provided with a flanged end fitting 130. The flanged end fitting 130 is provided with a body-accepting section 131 (shown in FIG. 2), which is, like the body-accepting portion 141 of the mounting fitting 140, shaped according to the body 110, and is therefore provided with a cylindrical opening and an inner surface that is cylindrical about an axis. The body-accepting section 131 is integrally cast with a flange 132 in a sand mold. As shown in FIG. 1, the flange 132 is generally circular and provided with a flange axis 133. The flange 132 cooperates with the yoke 300.

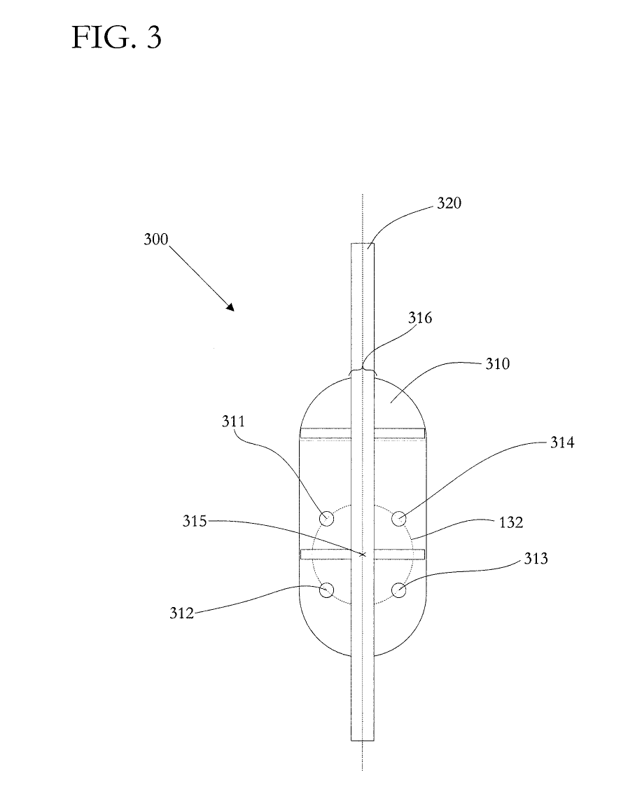

Referring now to FIG. 3, the yoke 300 is shown provided with a plate 310 (sometimes referred to herein as an “insulator plate 310” in order to distinguish this plate from other plates referred to herein). The plate 310 is shaped to cooperate with the flange 132 and is provided with a plurality of holes 311, 312, 313, 314 that are arranged about a yoke axis 315. One of skill in the art will understand that bolts extend through the holes 311, 312, 313, 314 to secure the yoke 300 to the first insulator 100. Once secured, the yoke axis 315 and the flange axis 133 are coaxial. Accordingly, the insulator plate 310 is oriented to be parallel to the flange 132 and thus fastened to the end of the flange 132.

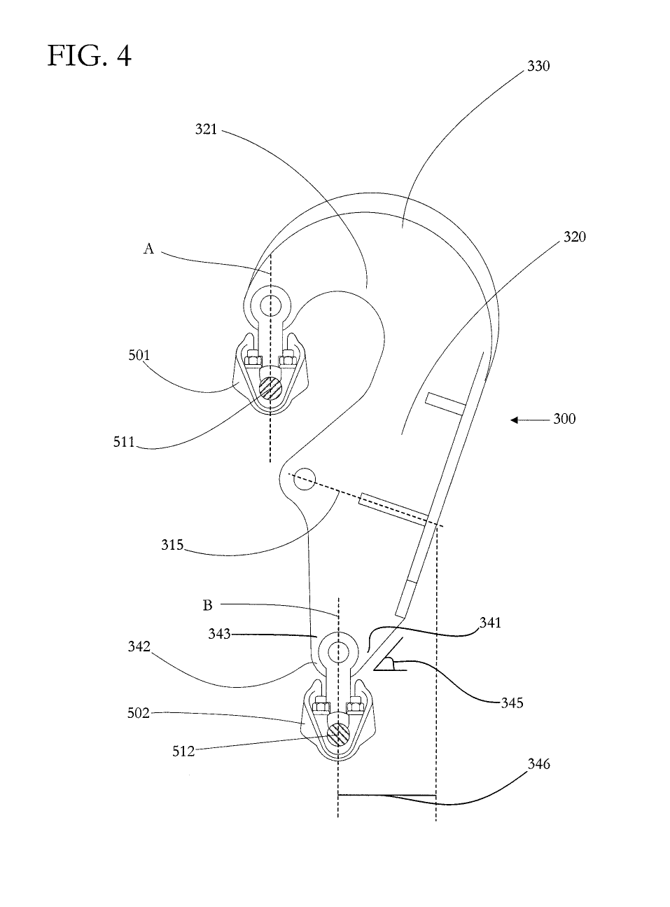

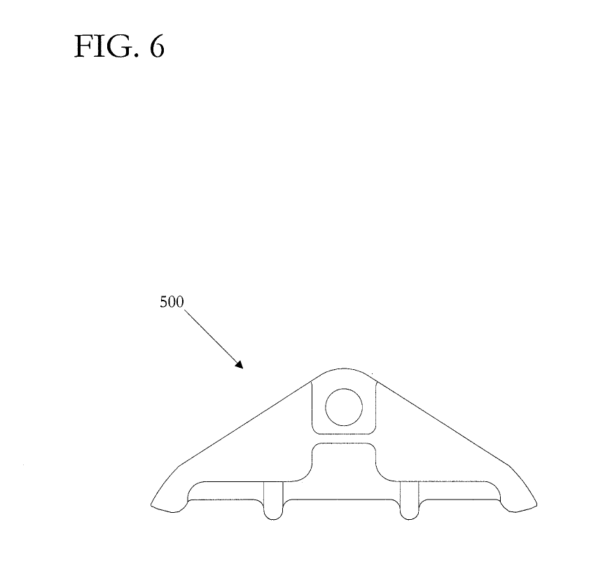

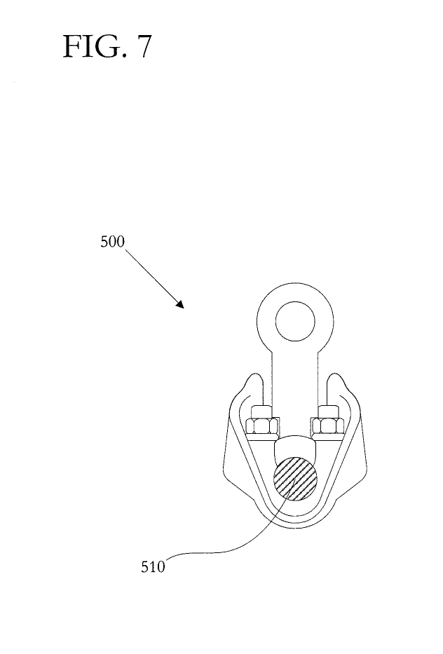

Extending from the insulator plate 310 at a 90° angle is an arm 320. The arm extends from the insulator plate 310 along the flange axis 133, across the central portion 316 of the insulator plate 310, and is shaped to retain a clamp (which has been designated generally as “500” in FIG. 6 and FIG. 7). In the preferred embodiment, the arm is shaped to retain a plurality of suspension clamps 501, 502 (referred to occasionally herein as a “first clamp 501” and a “second clamp 502” to distinguish one from the other). The clamp 500 retains an electric line 510, and thus, the first clamp 501 retains a “first electric line 511” and the second clamp 502 retains a “second electric line 512.” The arm 320 is configured to movably secure the suspension clamps 501, 502 and the electric lines 511, 512. As FIG. 4 illustrates, the suspension clamps 501, 502 are fixed axially but movably secured, at least in part, in a direction that is radial relative to each of the electric lines 511, 512.

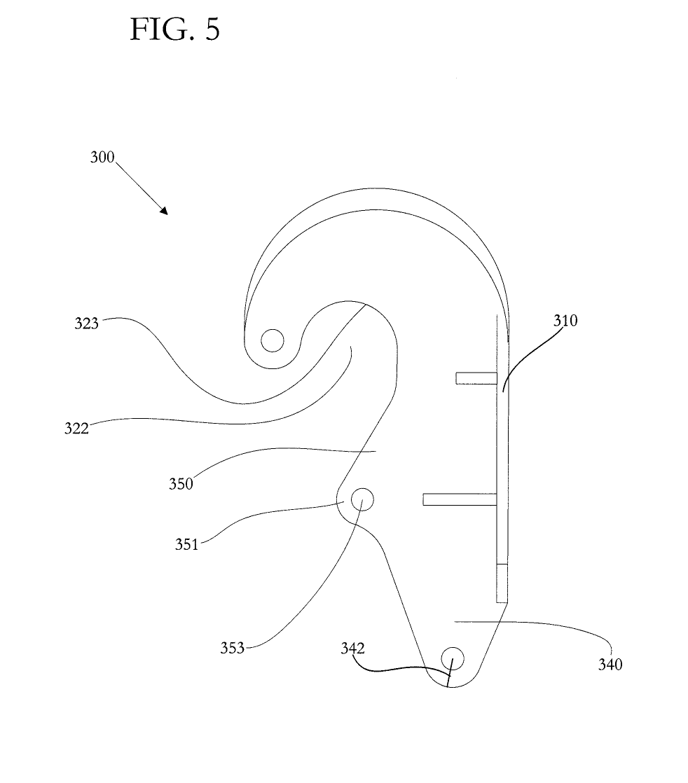

Integrally fabricated as part of the arm 320, a spacer 330, an extension 340, and a securing structure 350 are illustrated in FIGS. 4 and 5. The spacer 320 is provided with an extending section 321 that is preferably curved (at least in part). As FIG. 5 illustrates, the extending section 321 that is shaped according to at least one of the clamps 501, 502 (which secure the electric lines 511, 512). FIG. 6 depicts the arm 320 securing a suspension clamp 501 and hence holding an electric line 511. As FIG. 6 and FIG. 10 show, the electric line 511 is secured axially but, at the same time, able to swing into the recess 322 from imaginary line “A” (such as when the wind blows across the line 511). In the embodiment shown in FIG. 6, the line 511 is secured within the clamp 501, and therefore, the line 511 (and hence the clamp 501) sweep out an arc measuring 120°. By way of further illustration, the line 511 and the clamp 501 sweep out an arc measuring 75° on one side of imaginary line A and an arc measuring 75° on the other side of imaginary line A. Thus, in the embodiment depicted in FIG. 6, the line 511 and the clamp 501 sweep out an arc measuring)150° (75°+75°. The recess 322 is provided with a radius 323 that is dimensioned according to the clamp 501, and, in the preferred embodiment, measures between 2.3 and 3.1 inches. However, in alternative embodiments, the radius 323 can range between 1.75 and 3.5 inches.

In the preferred embodiment, the recess 322 is formed, at least in part, by the protrusion 351 (and hence, the recess 322 can be said to have been formed, at least in part, by the securing structure 350). However, in another embodiment, (such as that shown in FIG. 11), the protrusion 351 is not necessary, and hence, need not form the recess 322 as is disclosed in FIG. 5. The bolt hole 353 is shown formed within the protrusion 351 (though the bolt hole 353 could be located elsewhere within the arm 320). By way of example and not limitation, the bolt hole 353 can be located in the spacer 330.

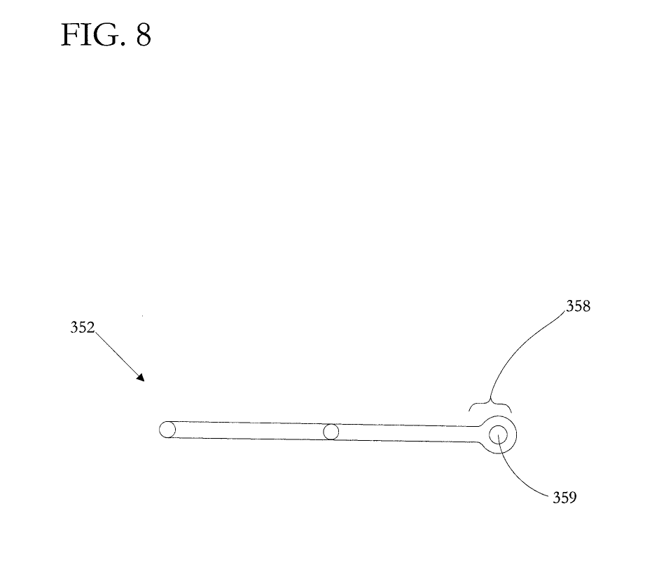

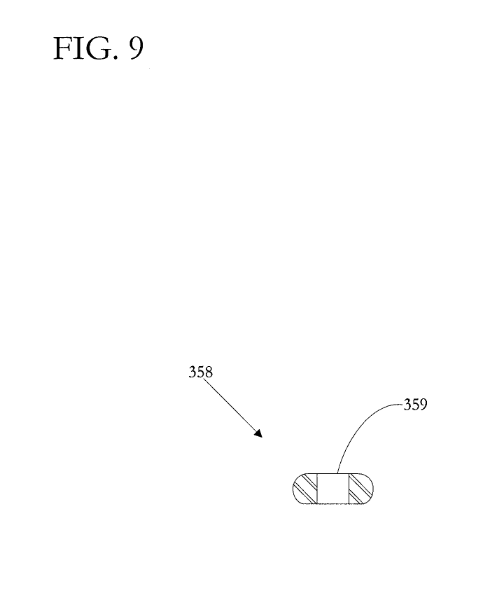

As noted above, the arm 320 is provided with a securing structure 350, which, in the preferred embodiment, includes a bolt hole 353 formed within the arm 320 that extends transverse relative to the plane of the arm 320, the protrusion 351, and a shackle 352. The shackle 352 is depicted in FIG. 8 and, as shown, in FIG. 9, is provided with an end 358 and a hole 359. The shackle 352 is in the shape of a “U” with shackle holes 354, 355 provided at the shackle ends 356, 357. The shackle 352 is provided with a “U” portion that extends through an end fitting crimped onto the end of the second insulator 200. The shackle holes 354, 355 receive a bolt that also extends through the bolt hole 353 formed within the protrusion 351.

As illustrated in FIG. 5, the extension 340 is dimensioned to separate the second clamp 502 from the first clamp 501. In FIG. 6, the extension 340 is shown located adjacent to the protrusion 351. The extension secures a suspension clamp 502 and hence holds an electric line 512. Much like the first line 511, the second electric line 512 is secured axially but, at the same time, able to swing about the extension 340 from imaginary line “B” (such as when the wind blows across the line 512). Because the line 512 is secured within the clamp 502, the line 512 (and hence the clamp 502) sweep out an arc measuring 150° (in the embodiment depicted in FIG. 5). By way of further illustration, the line 512 and the clamp 502 in FIG. 4 sweep out an arc measuring 75° on one side of imaginary line B and an arc measuring 75° on the other side of imaginary line B.

The extension 340 is provided with an end (referred to as an “extension end 341” to distinguish the end of the extension 340 from other ends disclosed herein). The extension end 341 is provided with a radius 342 that is dimensioned according to the clamp 502, and, in the preferred embodiment, measures between 1 and 2 inches (with the ideal radius 342 measuring 1.375 inches). As FIG. 4 illustrates, the extension end 341 is provided with a line attachment area generally designated via reference number “343”. Defined within the attachment area 343 is a hole 344. The hole 344 (and hence the attachment area 343 itself) provides a location where the clamp 502 (or other line-holding device) can be attached to the yoke 300. Referring again to FIG. 4, the attachment area 343 is offset from the plate 310. In the preferred embodiment, the extension end 341 is shaped to provide the offset 346 (which is depicted in FIG. 5) by contouring the extension end 341 away from the plate 310. As shown in FIG. 4, the extension end 341 is provided with an angle 345 that effectively shapes the extension end 341 so that the attachment area 343 is offset from plate 310. The offset 346 spaces the attachment area 343 away from the end fitting 130 and any hardware associated therewith (such as a corona ring). Thus, the yoke 300 provides a swing angle of 75° in the embodiment shown in FIG. 4.

Referring now to FIG. 2, the second insulator 200 is a suspension insulator provided with a body 210 composed of a composite material; preferably, the composite material is a fiberglass extruded as a cylinder and provided with an axis 201. As FIG. 1 illustrates, the second insulator 200 is provided with a housing (designated “220” in FIG. 2) that includes a sheath 221, a plurality of sheds 222, and a housing axis 223. In one embodiment, a sheath 221 of the second insulator 200 is composed of a silicone rubber that has been extruded over the body 210. The sheds 222 are then glued onto the sheath 221. The preferred embodiment is provided with a body 210 of extruded fiberglass and a housing 220 of silicone rubber molded thereon, in an alternative embodiment, the body 210 is a polyester or an aramid, and the housing 220 is rubber that has been extruded onto the body 210. In yet another alternative embodiment, the housing 220 is composed of an RTV rubber or an EPDM.

The second insulator 200 is provided with a plurality of fittings that have been crimped onto each end 230, 240 of the body 210. In the preferred embodiment, the end fittings are tongue-style end fittings; however, other styles of end fittings are within the scope of the present invention.

While this invention has been particularly shown and described with references to embodiments thereof, it will be understood by those skilled in the art that various changes in form and details may be made therein without departing from the spirit and scope of the invention as defined by the appended claims.

What is claimed is:

1. An insulating assembly for securing a plurality of power lines, comprising:
a) a suspension insulator that is provided with a first end fitting;
b) a bracing insulator that is provided with a second end fitting;
c) a yoke that is configured to secure the insulators, a first clamp holding a first power line, and a second clamp holding a second power line;
d) the yoke is shaped so that the clamps are provided with swing angles that electrically isolate the power lines from one another; and
e) the insulators are secured to the yoke so that each of the end fittings is electrically isolated from each of the power lines.

2. An insulating assembly according to claim 1 wherein the yoke further includes a securing structure that is configured to accommodate a shackle that secures the suspension insulator to the yoke.

3. An insulating assembly according to claim 1 wherein the yoke further includes a plate that secures the bracing insulator to the yoke.

4. An insulating assembly according to claim 1 wherein the yoke further includes a recess that is shaped to allow at least one of the clamps to swing freely therein.

5. An insulating assembly according to claim 1 wherein the yoke further includes an extension that electrically isolates the second end fitting from the power lines.

6. A yoke for holding a plurality of power lines, comprising:
a) a plate that is configured to be attached to a first insulator;
b) an arm provided with a spacer, a securing structure, and an extension;
c) the securing structure is configured to secure a second insulator to the yoke;
d) the spacer includes an extending section that is configured to secure a first power line;
e) the extension includes an extension end that is configured to secure a second power line; and
f) the extending section and the extension end are spaced so that the power lines are electrically isolated from one another.

7. A yoke for holding a plurality of power lines according to claim 6 wherein the yoke further includes a recess that is shaped to provide a swing angle for at least one of the power lines.

8. A yoke for holding a plurality of power lines according to claim 6 wherein the extension end is shaped to provide a swing angle for at least one of the power lines.

9. A yoke for holding a plurality of power lines according to claim 6 wherein the first insulator is a bracing insulator and the second insulator is a suspension insulator.

10. A yoke for holding a plurality of power lines according to claim 6 wherein
a) the first insulator is provided with an end fitting that is secured to the plate;
b) a clamp that retains at least one of the power lines is secured to the extension end; and
c) the extension end is shaped so that the power line retained within the claim is electrically isolated from the end fitting.

11. A yoke for holding a plurality of power lines according to claim 6 wherein the yoke further includes a recess that is shaped to allow at least one of the clamps to swing freely therein.

12. A yoke for holding a plurality of power lines according to claim 6 wherein the yoke spatially separates the power lines so that each power line is electrically isolated from the other.

13. An insulating assembly for holding a plurality of power lines, comprising:
a) a first insulator and a second insulator wherein the insulators are secured to a yoke;
b) the yoke includes an arm provided with a spacer and an extension;
c) the spacer includes a section that is configured to secure a first clamp which retains a first power line;
d) the extension includes an end that is configured to secure a second clamp which retains a second power line; and
e) the section of spacer is spatially separated from the end of the extension so that the power lines are electrically isolated from one another.

14. An insulating assembly according to claim 13 wherein:
a) the second insulator is a suspension insulator;
b) the yoke includes a securing structure;
c) the securing structure is configured to accommodate a shackle that secures the suspension insulator to the yoke.

15. An insulating assembly according to claim 13 wherein:
a) the first insulator is a bracing insulator;
b) the yoke includes a plate; and
c) the plate secures the bracing insulator to the yoke.

16. An insulating assembly according to claim 13 wherein the yoke further includes a recess that is shaped to allow at least one of the clamps to swing freely therein.

17. An insulating assembly according to claim 13 wherein:
a) the first insulator is provided with an end fitting;
b) the extension electrically isolates the end fitting from the second power line.
